(19) United States
(12) Patent Application Publication
(10) Pub. No.: US 2024/0219713 A1
(43) Pub. Date: Jul. 4, 2024

(54) METHOD AND APPARATUS FOR OPTIMIZING SURFACE SHAPE OF REFLECTING MIRROR

(71) Applicant: Institute of Advanced Science Facilities, Shenzhen, Shenzhen (CN)

(72) Inventor: Zhongmin Xu, Shenzhen (CN)

(21) Appl. No.: 18/402,128

(22) Filed: Jan. 2, 2024

(30) Foreign Application Priority Data
Jan. 4, 2023 (CN) 202310009881.2

(51) Int. Cl. G02B 27/00

(52) U.S. Cl. CPC G02B 27/0012

(57) ABSTRACT

The present disclosure provides a method and an apparatus for optimizing surface shape of a reflecting mirror. The method for optimizing surface shape of the reflecting mirror includes: determining each heat flux vector based on a response matrix, a thermal deformation vector and each perturbation term; determining each residual surface shape error based on the response matrix, the thermal deformation vector and each heat flux vector satisfying constraint conditions; and applying a heat flux vector corresponding to a minimum value of each residual surface shape error to a heating sheet of the reflecting mirror to optimize the surface shape of the reflecting mirror. The present disclosure may quickly determine an effective surface shape optimization scheme and meet the requirement of high-precision surface shape.

### CROSS-REFERENCE TO RELATED APPLICATIONS

This application claims priority to Chinese Patent Application No. 202310009881.2, filed on Jan. 4, 2023, which is hereby incorporated by reference in its entirety.

### TECHNICAL FIELD

The present disclosure relates to the technical field of optical system surface shape optimization, in particular to a method and an apparatus for optimizing surface shape of a reflecting mirror.

### BACKGROUND

Due to the requirement of coherent transmission of the wave-front, the fourth-generation synchrotron radiation light source and the high pulse repetition frequency free-electron laser device have very high requirements on surface shape of a reflecting mirror. It is generally required that a RMS (Root Mean Square) error of the height should be several nanometers (nm) and a RMS (Root Mean Square) error of the slope should be less than 100 nano-radian (nrad) magnitude. When the reflecting mirror absorbs the X-ray from the upstream, it will lead to the thermal deformation of the mirror surface, which will eventually adversely affect the transmission efficiency and transmission quality of the X-ray.

Conventional cooling schemes have been unable to meet such high accuracy surface-shape requirements. At present, active surface shape control schemes include water cooling and multi-channel piezoelectric ceramic surface shape control schemes designed by Thelas SESO, and have been applied in DLS (Diamond Light Source), ESRF (European Synchrotron Radiation Facility), EU-XFEL (European X-ray Free Electron Laser) and other light sources; and the SLAC (Stanford Linear Accelerator Center) National Accelerator Laboratory in the United States has proposed a REAL (Resistive Element Adjustable Length) cooling scheme using an electric heater (i.e. electric heating sheet) for temperature compensation.

The scheme of the electric heater generally uses more than ten electric heaters to compensate the surface shape of the reflecting mirror. In order to obtain the voltage (or current) applied to the electric heaters, the conventional method is to set the range of the voltage (or current) applied to each electric heater in a finite element analysis software, and the voltage (or current) on each electric heater when the surface shape is minimum is obtained by the method of multi-parameter optimization. Optimization with more than ten parameters is not only a very time-consuming task, but also limited by the optimization algorithm, and the results meeting requirements may not be available.

### SUMMARY

The main object of an embodiment of the present disclosure is to provide a method for optimizing the surface shape of a reflecting mirror, so as to quickly determine an effective surface shape optimization scheme to meet the requirement of high-precision surface shape.

In order to achieve the above object, an embodiment of the present disclosure provides a method for optimizing the surface shape of a reflecting mirror, including:
determining each heat flux vector based on a response matrix, a thermal deformation vector and each perturbation term;
determining each residual surface shape error based on the response matrix, the thermal deformation vector and each heat flux vector satisfying constraint conditions; and
applying a heat flux vector corresponding to a minimum value of each residual surface shape error to a heating sheet of the reflecting mirror to optimize the surface shape of the reflecting mirror.

In an embodiment, the method further includes:
applying heat flux vectors sequentially to each heating sheet to obtain corresponding reflecting mirror heat flux deformation data; and
determining the response matrix from the reflecting mirror heat flux deformation data.

In an embodiment, the method further includes:
applying light source thermal power to light spots of the reflecting mirror to obtain thermal deformation data of the reflecting mirror; and
determining the thermal deformation vector based on the thermal deformation data of the reflecting mirror.

In an embodiment, the determining each heat flux vector based on the response matrix, the thermal deformation vector and each perturbation term includes:
determining each total deformation perturbation vector based on the thermal deformation vector, an initial deformation vector and each perturbation term; and
determining each heat flux vector based on the response matrix and each total deformation perturbation vector.

In an embodiment, the determining each total deformation perturbation vector based on the thermal deformation vector, the initial deformation vector and each perturbation term includes:
determining each thermal deformation perturbation vector based on a maximum value of the thermal deformation vectors, and each perturbation term; and
determining each total deformation perturbation vector based on the thermal deformation vector, the initial deformation vector and each thermal deformation perturbation vector.

In an embodiment, the determining each heat flux vector based on the response matrix and the total deformation perturbation vector includes:
determining each heat flux vector based on an inverse matrix of a product of the response matrix and a transposition of the response matrix, the transposition of the response matrix and each total deformation perturbation vector.

In an embodiment, the determining each heat flux vector by an equation includes the following equation:

H=(M^{T}(x)M(x))⁻¹M^{T}(x)(−C(x)−K(x)+((max(K(x))+ε)I);

where, M(x) denotes the response matrix, H denotes the heat flux vector, C(x) denotes the initial deformation vector; K(x) denotes the thermal deformation vector, ε denotes the perturbation term, and −C(x)−K(x)+(max(K(x))+ε)I denotes the total deformation perturbation vector. In addition, it should be noted that the equals sign (=) in the above equation may be interpreted as roughly equal, i.e. approximately equal (≈).

In an embodiment, the determining each residual surface shape error based on the response matrix, the thermal deformation vector and each heat flux vector satisfying constraint conditions includes:
determining each thermal deformation perturbation vector based on a maximum value of the thermal deformation vectors, and each perturbation term; and
determining each residual surface shape error based on the response matrix, the thermal deformation vector, an initial deformation vector, each thermal deformation perturbation vector and each heat flux vector satisfying constraint conditions.

In an embodiment, the determining each residual surface shape error by an equation includes the following equation:

e=M(x)H′+C(x)+K(x)−((max(K(x))+ε)I);

where, e denotes the residual surface shape error, M(x) denotes the response matrix, H′ denotes the heat flux vector satisfying constraint conditions, C(x) denotes the initial deformation vector; K(x) denotes the thermal deformation vector, ε denotes the perturbation term, and (max(K(x))+ε)I denotes the thermal deformation perturbation vector.

An embodiment of the present disclosure further provides an apparatus for optimizing surface shape of a reflecting mirror, including:
a heat flux vector module configured to determine each heat flux vector based on a response matrix, a thermal deformation vector and each perturbation term;
a residual surface shape error module configured to determine each residual surface shape error based on the response matrix, the thermal deformation vector and each heat flux vector satisfying constraint conditions; and
a surface shape optimization module configured to apply a heat flux vector corresponding to a minimum value of each residual surface shape error to a heating sheet of the reflecting mirror to optimize the surface shape of the reflecting mirror.

In an embodiment, the apparatus further includes:
a heat flux vector application module configured to apply heat flux vectors sequentially to each heating sheet to obtain corresponding reflecting mirror heat flux deformation data; and
a response matrix module configured to determine the response matrix from the reflecting mirror heat flux deformation data.

In an embodiment, the apparatus further includes:
a thermal power application module configured to apply light source thermal power to light spots of the reflecting mirror to obtain thermal deformation data of the reflecting mirror; and
a thermal deformation vector module configured to determine the thermal deformation vector based on the thermal deformation data of the reflecting mirror.

In an embodiment, the heat flux vector module includes:
a total deformation perturbation vector unit configured to determine each total deformation perturbation vector based on the thermal deformation vector, an initial deformation vector and each perturbation term; and
a heat flux vector unit configured to determine each heat flux vector based on the response matrix and each total deformation perturbation vector.

In an embodiment, the total deformation perturbation vector unit includes:
a thermal deformation perturbation vector sub-unit configured to determine each thermal deformation perturbation vector based on a maximum value of the thermal deformation vectors, and each perturbation term; and
a total deformation perturbation vector sub-unit configured to determine each total deformation perturbation vector based on the thermal deformation vector, the initial deformation vector and each thermal deformation perturbation vector.

In an embodiment, the heat flux vector unit is specifically configured to:
determine each heat flux vector based on an inverse matrix of a product of the response matrix and a transposition of the response matrix, the transposition of the response matrix and each total deformation perturbation vector.

In an embodiment, the heat flux vector module is specifically configured to:
determine each heat flux vector an equation includes the following equation:

H=(M^{T}(x)M(x))⁻¹M^{T}(x)(−C(x)−K(x)+(max(K(x))+ε)I);

where, M(x) denotes the response matrix, H denotes the heat flux vector, C(x) denotes the initial deformation vector; K(x) denotes the thermal deformation vector, ε denotes the perturbation term, and −C(x)−K(x)+(max(K(x))+ε)I denotes the total deformation perturbation vector. In addition, it should be noted that the equals sign (=) in the above equation may be interpreted as roughly equal, i.e. approximately equal (≈).

In an embodiment, the residual surface shape error module includes:
a thermal deformation perturbation vector unit configured to determine each thermal deformation perturbation vector based on a maximum value of the thermal deformation vectors, and each perturbation term; and
a residual surface shape error unit configured to determine each residual surface shape error based on the response matrix, the thermal deformation vector, an initial deformation vector, each thermal deformation perturbation vector and each heat flux vector satisfying constraint conditions.

In an embodiment, the residual surface shape error module is specifically configured to:
determine each residual surface shape error by an equation includes the following equation:

e=M(x)H′+C(x)+K(x)−((max(K(x))+ε)I);
where, e denotes the residual surface shape error, M(x) denotes the response matrix, H′ denotes the heat flux vector satisfying constraint conditions, C(x) denotes the initial deformation vector; K(x) denotes the thermal deformation vector, ε denotes the perturbation term, and (max(K(x))+ε)I denotes the thermal deformation perturbation vector.

An embodiment of the present disclosure further provides an electronic device, including a memory, a processor, and a computer program stored on the memory and runnable on the processor, and the processor executes the computer program to implement steps of the method for optimizing the surface shape of the reflecting mirror.

The embodiment of the present disclosure further provides a computer-readable storage medium which stores a computer program, and when executed by a processor, the computer program implements the steps of the method for optimizing the surface shape of the reflecting mirror.

The embodiment of the present disclosure further provides a computer program product includes a computer program/instruction, and when executed by a processor, the computer program/instruction implements the steps of the method for optimizing the surface shape of the reflecting mirror.

The method and the apparatus for optimizing surface shape of the reflecting mirror according to the embodiment of the present disclosure firstly determine each heat flux vector based on a response matrix, a thermal deformation vector and each perturbation term; then determine each residual surface shape error based on the response matrix, the thermal deformation vector and each heat flux vector satisfying constraint conditions; and finally apply a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

### BRIEF DESCRIPTION OF THE DRAWINGS

In order to more clearly illustration the technical solution in the embodiments of the disclosure or the prior art, a brief description of the drawings for the embodiments will be given below. Obviously, the drawings in the following description are merely some examples of the disclosure, and for those of ordinary skill in the art, other drawings can be derived from these drawings without any inventive efforts.

FIG. 1 is a front view of a surface shape control structure of the reflecting mirror in an embodiment of the present disclosure;

FIG. 2 is a cross-sectional view of a surface shape control structure of the reflecting mirror in an embodiment of the present disclosure;

FIG. 3 is a flow chart of a surface shape optimization method based on FIGS. 1 and 2 in an embodiment of the present disclosure;

FIG. 4 is another flow chart of a surface shape optimization method based on FIGS. 1 and 2 in another embodiment of the present disclosure;

FIG. 5 is a flow chart of S101 in the embodiment of the present disclosure;

FIG. 6 is a deformation curve of the reflecting mirror when temperature compensation by an electric heater is not used;

FIG. 7 is a slope curve of the reflecting mirror when temperature compensation by an electric heater is not used;

FIG. 8 is a deformation curve of the reflecting mirror in which a heat flux vector is applied to a heating sheet;

FIG. 9 is a slope curve of the reflecting mirror in which a heat flux vector is applied to a heating sheet;

FIG. 10 is a structural block diagram of an apparatus for optimizing surface shape of a reflecting mirror according to an embodiment of the present disclosure;

FIG. 11 is a structural block diagram of an electronic device according to an embodiment of the disclosure.

### DETAILED DESCRIPTION

The technical solution in the embodiments of the present disclosure will be clearly and completely described below in conjunction with the drawings in the embodiments of the present disclosure, and obviously the described embodiments are merely part of the embodiments, not all of the embodiments. Based on the embodiments of the present disclosure, all other embodiments that are obtained by persons skilled in the art without making creative efforts fall within the protection scope of the present disclosure.

Those skilled in the art will appreciate that the embodiment of the present disclosure may be implemented as a system, a device, an apparatus, a method, or a computer program product. Accordingly, the present disclosure may be embodied in the form of complete hardware, complete software (including firmware, resident software, microcode, etc.), or combination of hardware and software.

In view of the fact that the current surface shape control scheme cannot meet the requirement of high-precision surface shape, an embodiment of the present disclosure provides a method and an apparatus for optimizing surface shape of a reflecting mirror, in which the surface shape optimization is performed by SVD (singular value decomposition) to obtain the heat flux vector applied on the electric heater (i.e. electric heating sheet); by searching perturbation terms of the objective function, not only various constraints can be set on the heat flux vector applied to the electric heater, but also the value of the heat flux vector on the electric heater can be quickly obtained when the surface shape is minimum. In the disclosure, simple matrix calculation is used, and the heat flux vectors applied to the plurality of electric heaters can be quickly obtained when the surface shape is minimum only by optimizing one perturbation term, so as to solve the very time-consuming of multi-parameter optimization performed by an optimization algorithm provided by traditional finite element analysis software. For example, the deflection mirror of FEL1 of S3FEL (Shenzhen Superconducting Soft X-ray Free-electron Laser) absorbs 5.4 W of thermal power, in the disclosure, the optimization calculation of the heat flux vectors of 25 electric heaters with minimum surface shape can be completed in a few seconds, the RMS error of the height decreases from 40 nm before compensation to 0.009 nm, and the slope error decreases from 192.7 nrad to 0.4 nrad. The present disclosure will be described in detail below in conjunction with the drawings.

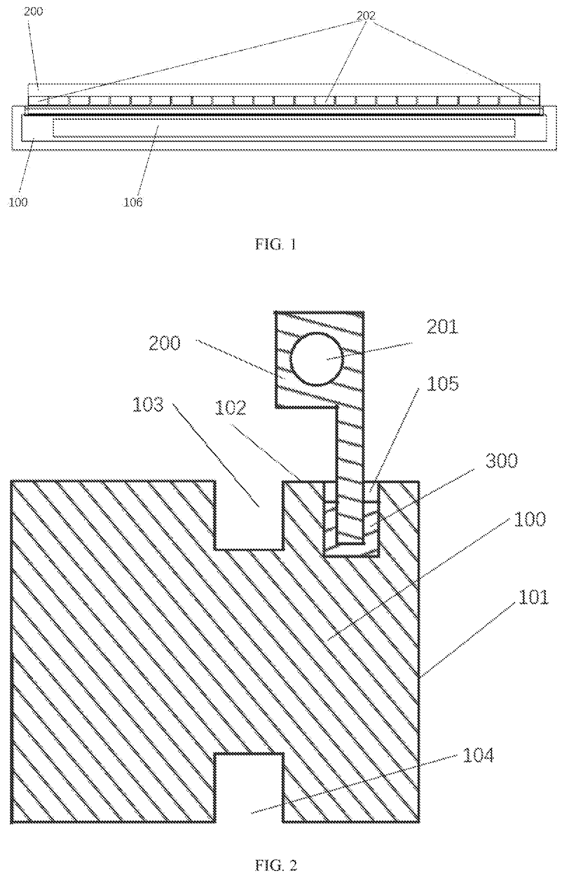

The present disclosure is applied to a surface shape control structure of a reflecting mirror. FIG. 1 is a front view of a surface shape control structure of the reflecting mirror in an embodiment of the present disclosure, FIG. 2 is a cross-sectional view of a surface shape control structure of the reflecting mirror in an embodiment of the present disclosure. As shown in FIGS. 1 and 2, the surface shape control structure of the reflecting mirror includes an optical element body 100, a water-cooled copper plate 200, an indium gallium solution tank 105, a first stress relieving tank 103, a second stress relieving tank 104, and an electric heater 202.

The optical element body 100 (such as reflecting mirror body) is provided with a reflecting surface 101, an upper surface 102 and an indium gallium solution tank 105. Both the reflecting surface 101 and the indium gallium solution tank 105 extend along a length direction of the optical element body 100 (reflecting mirror body), and the reflecting surface 101 is used to reflecting X-rays to obtain a light spot 106. An indium gallium solution tank 105 is provided on the upper surface 102 of the reflecting mirror, and the tank is filled with an indium gallium solution 300.

The material of the optical element body 100 is monocrystalline silicon, and the length, width, and height are 850 mm, 50 mm, and 60 mm, respectively. The lower end of the water-cooled copper plate 200 is immersed in the indium gallium solution 300 and spaced from the bottom surface of the indium gallium solution tank 105 by 2 mm. The inner diameter of the pipe 201 in the water-cooled copper plate 200 is 8 mm. The reflecting mirror surface absorbs 5.4 W of power and water at 25° C. is introduced into the pipe 201. As shown in FIG. 1, there are totally 25 electric heaters, and the size of the electric heater is 30 mm×10 mm, and the interval between them is 2 mm.

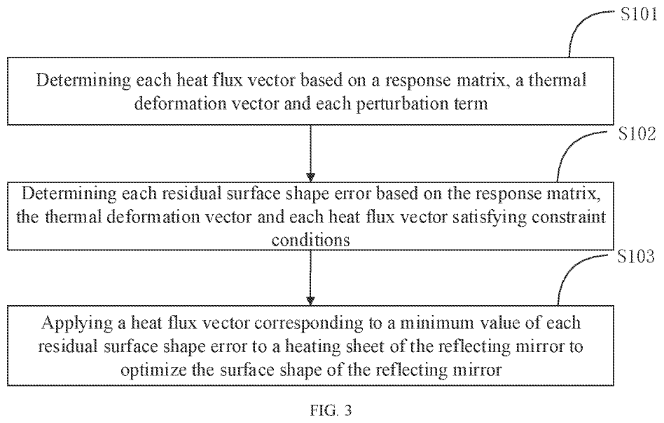

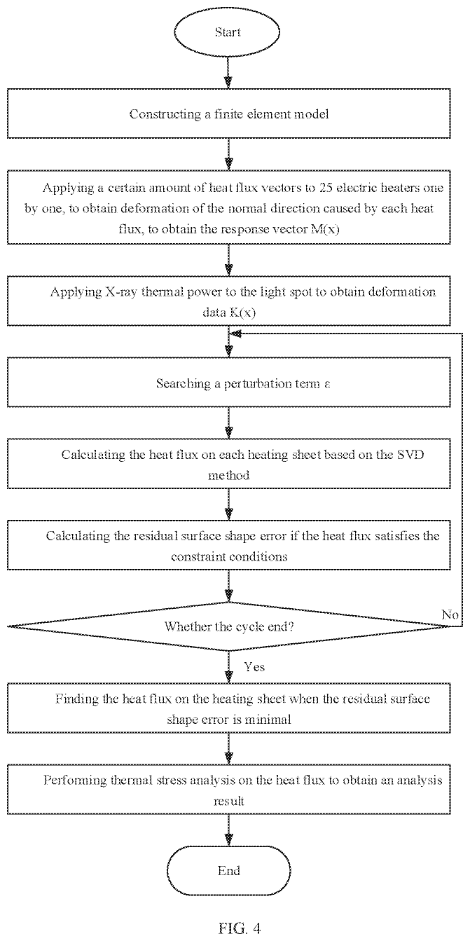

FIG. 3 is a flow chart of the method for optimizing the surface shape of the reflecting mirror according to an embodiment of the present disclosure. FIG. 4 is another flow chart of the method for optimizing the surface shape of the reflecting mirror according to another embodiment of the present disclosure. As shown in FIGS. 3 and 4, the method for optimizing the surface shape of the reflecting mirror includes:

S101: determining each heat flux vector based on a response matrix, a thermal deformation vector and each perturbation term.

Before S101, the method further includes: applying heat flux vectors sequentially to each heating sheet to obtain corresponding reflecting mirror heat flux deformation data, and determining the response matrix from the reflecting mirror heat flux deformation data, applying light source thermal power to light spots of the reflecting mirror to obtain thermal deformation data of the reflecting mirror, and determining the thermal deformation vector based on the thermal deformation data of the reflecting mirror.

FIG. 5 is a flow chart of S101 in the embodiment of the present disclosure. As shown in FIG. 5, S101 includes:

S201: determining each total deformation perturbation vector based on the thermal deformation vector, an initial deformation vector and each perturbation term.

In an embodiment, S201 includes: determining each thermal deformation perturbation vector based on a maximum value of the thermal deformation vectors, and each perturbation term, and determining each total deformation perturbation vector based on the thermal deformation vector, the initial deformation vector and each thermal deformation perturbation vector.

In specific implementation, the thermal deformation perturbation vector is (max(K(x))+ε)I, the total deformation perturbation vector is −C(x)−K(x)+(max(K(x))+ε)I, where, K(x) is the thermal deformation vector, ε is the perturbation term, C(x) is the initial deformation vector, and I is a unit matrix.

S202: determining each heat flux vector based on the response matrix and each total deformation perturbation vector.

In an embodiment, S202 includes determining each heat flux vector based on an inverse matrix of a product of the response matrix and a transposition of the response matrix, the transposition of the response matrix and each total deformation perturbation vector.

In specific implementation, an inverse matrix of a product of the response matrix and the transposition of the response matrix is (M^{T}(x)M(x))⁻¹, and M(x) is the response matrix. The heat flux vector can be determined by the following equation:

H=(M^{T}(x)M(x))⁻¹M^{T}(x)(−C(x)−K(x)+(max(K(x))+ε)I);

where, H denotes a heat flux vector applied on the electric heater, and is a heat flux vector corresponding to all perturbation items within a value range of the perturbation items; M(x) denotes the response matrix, K(x) denotes the thermal deformation vector, C(x) denotes the initial deformation vector, and e denotes the perturbation term. In addition, it should be noted that the equals sign (=) in the above equation may be interpreted as roughly equal, i.e. approximately equal (≈).

In the present disclosure, the heat flux vector is used instead of the voltage (or current) in the finite element analysis, and their effects of temperature compensation are consistent. The purpose of surface shape compensation is to apply a heat flux vector to a plurality of electric heaters so that the surface shape is as small as possible by reducing the meridional square temperature gradient. Therefore, an MHCKF (that is a combination of all parameters in the following equation (1)) model for reflecting mirror surface shape compensation is constructed, as shown in the following equation (1):

M(x)H+C(x)+K(x)=F(x); (1)

where, x denotes the coordinate of the light spot in the meridian direction; M(x) denotes the response function (response matrix) of the electric heater, M(X)∈R^{m×n}, m denotes the number of rows of M(x), n denotes the number of columns of M(x); H denotes a heat flux vector (column vector) applied on the electric heater, H∈Rⁿ; C(x) denotes the initial deformation vector, which is affected by many factors such as reflecting mirror machining, clamping and gravity. C(X)∈R^{m}; K(x) denotes a deformation column vector (thermal deformation vector) produced by the reflecting mirror absorbing the X-ray power, K(x)∈R^{m}; F(x) denotes the deformation distribution produced by the combined action of the electric heater surface shape compensation, the initial deformation and the thermal deformation of the reflecting mirror, which is usually very complicated, F(x)∈R^{m}.

It has been found that the ideal case of F(x) is a straight line and the simplest case is:

F(x)=(max(K(x))+ε)I; (2)

where, max(K(x)) denotes the maximum deformation value of K(x), ε denotes the perturbation term, which is a scalar, I denotes a column vector of all 1's (unit matrix). In addition, it should be noted that the equals sign (=) in the above equation (2) may be interpreted as roughly equal, i.e. approximately equal (≈).

The following equations (3) to (6) can be obtained based on the equations (1) and (2), as follows:

M(x)H+C(x)+K(x)=(max(K(x))+ε)I; (3)

M(x)H=−C(x)−K(x)+(max(K(x))+ε)I; (4)

M^{T}(x)M(x)H=M^{T}(x)(−C(x)−K(x)+(max(K(x))+ε)I); (5)

H=(M^{T}(x)M(x))⁻¹M^{T}(x)(−C(x)−K(x)+(max(K(x))+ε)I); (6)

where, T denotes the transposition, −1 denotes the inverse matrix. In addition, it should be noted that the equals sign (=) in the above equation (3)˜(6) may be interpreted as roughly equal, i.e. approximately equal (≈).

Gravity has very little effect on the surface shape of the reflecting mirror when it is placed sideways. In addition, a stress-free reflecting mirror clamping scheme is adopted in engineering, and surface shape errors caused by machining are generally not considered in finite element analysis, therefore, the initial deformation vector C(x) is usually measured by an interferometer after the reflecting mirror is installed, and can be neglected temporarily in finite element simulation.

S102: determining each residual surface shape error based on the response matrix, the thermal deformation vector and each heat flux vector satisfying constraint conditions.

In an embodiment, S102 includes: determining each thermal deformation perturbation vector based on a maximum value of the thermal deformation vectors, and each perturbation term, and determining each residual surface shape error based on the response matrix, the thermal deformation vector, an initial deformation vector, each thermal deformation perturbation vector and each heat flux vector satisfying constraint conditions.

In specific implementation, each residual surface shape errors can be determined by the following equation:

e=M(x)H′+C(x)+K(x)−((max(K(x))+ε)I).

where, e denotes the residual surface shape error, M(x) denotes the response matrix, H′ denotes the heat flux vector satisfying constraint conditions, C(x) denotes the initial deformation vector; K(x) denotes the thermal deformation vector, and (max(K(x))+ε)I denotes the thermal deformation perturbation vector. The PV (Peak-to-Valley) and RMS (Root Mean Square) values of the height error or the slope error can be obtained from the residual surface shape errors.

S103: applying a heat flux vector corresponding to a minimum value of each residual surface shape error to a heating sheet of the reflecting mirror to optimize the surface shape of the reflecting mirror.

An executing body of the method for optimizing the surface shape of the reflecting mirror shown in FIG. 3 may be a computer. As can be seen from the flow charts shown in FIGS. 3 and 4, in the method for optimizing the surface shape of the reflecting mirror according to the embodiment of the disclosure, firstly a finite element model of the optical system is established, and then the response data of the electric heater is calculated, i.e., a certain amount of heat flux vectors are applied one by one in the finite element model, and the deformation of the reflecting mirror is calculated, to obtain the response matrix M(x). The thermal deformation vector K(x) is then obtained by applying X-ray thermal power to the light spot alone. Then the perturbation terms are searched in the value range of the perturbation terms, and the heat flux vector on the heating sheet is obtained according to the SVD algorithm and H=(M^{T}(x)M(x))⁻¹M^{T}(x)(−C(x)−K(x)+(max(K(x))+ε)I). It should be noted that the equals sign (=) in the above equation may be interpreted as roughly equal, i.e. approximately equal (≈). If the heat flux vector satisfies the constraint condition, the residual surface shape error is calculated. At the end of the cycle, the heat flux vector corresponding to the minimum residual surface shape error is found, and by applying the heat flux vector to the heating sheet, the surface shape of the reflecting mirror can be optimized, to meet the requirement of high-precision surface shape under high efficiency.

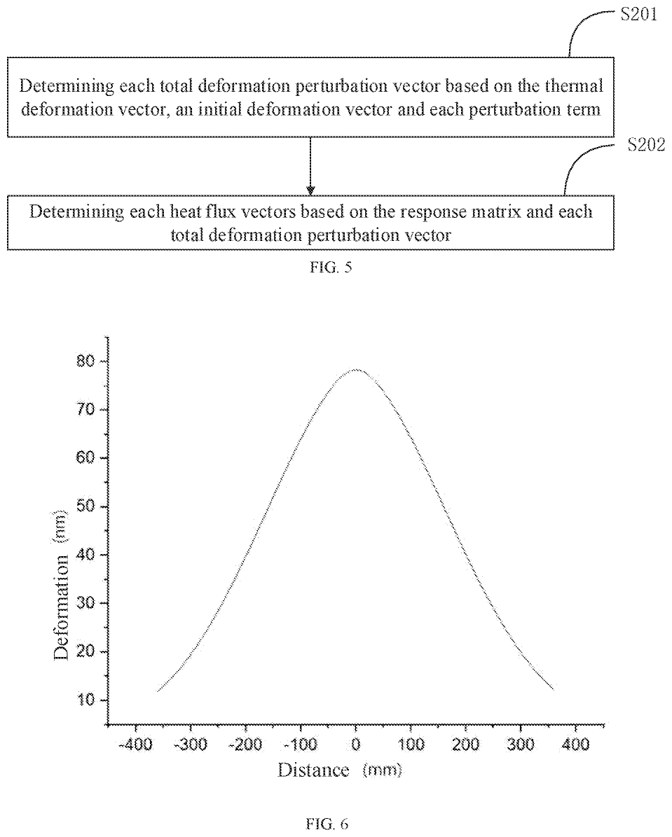

FIG. 6 is a deformation curve of the reflecting mirror when temperature compensation by an electric heater is not used. FIG. 7 is a slope curve of the reflecting mirror when temperature compensation by an electric heater is not used. As shown in FIGS. 6 and 7, the horizontal axis of FIGS. 6 and 7 represents the distance of the reflecting mirror from the center of the light spot, the vertical axis of FIG. 6 represents the deformation data of the reflecting mirror, and the vertical axis of FIG. 7 represents the slope data of the reflecting mirror. From FIG. 6 and FIG. 7, the RMS value of the height error can be obtained to be 40 nm, and the RMS value of the slope error can be obtained to be 192.7 nrad, respectively.

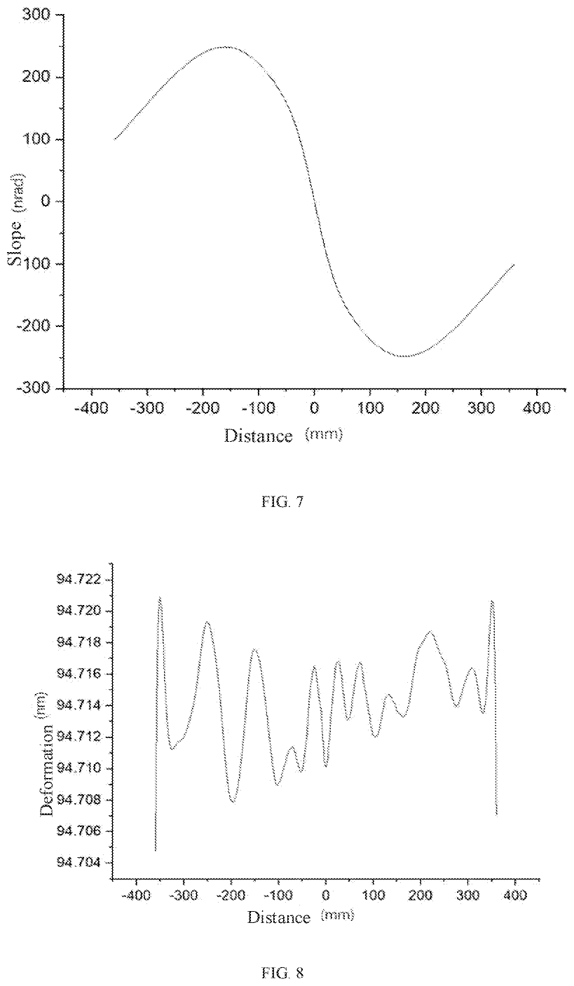

FIG. 8 is a deformation curve of the reflecting mirror in which a heat flux vector is applied to a heating sheet. FIG. 9 is a slope curve of the reflecting mirror in which a heat flux vector is applied to a heating sheet. As shown in FIGS. 8 and 9, after the heat flux vector of 0.001 W/mm²/° C. is applied to the heating sheet, the RMS value of the height error is 0.009 nm and the RMS value of the slope error is 0.4 nrad, which is several orders of magnitude lower than that before optimization. Therefore, the surface shape optimization scheme provided by the present disclosure is feasible and can meet the stringent surface shape requirements of the fourth-generation synchrotron radiation light source and the high pulse repetition frequency free-electron laser device.

In summary, the method for optimizing surface shape of the reflecting mirror according to the embodiment of the present disclosure firstly determines each heat flux vector based on a response matrix, a thermal deformation vector and each perturbation term; then determines each residual surface shape error stringent the response matrix, the thermal deformation vector and each heat flux vector satisfying constraint conditions; and finally applies a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

Based on the same inventive concept, an embodiment of the present disclosure further provides an apparatus for optimizing surface shape of a reflecting mirror. Since the principle for solving the problem by the apparatus is similar to that of the method for optimizing surface shape of the reflecting mirror, the implementation of the apparatus can refer to the implementation of the method, with repetitions being not described.

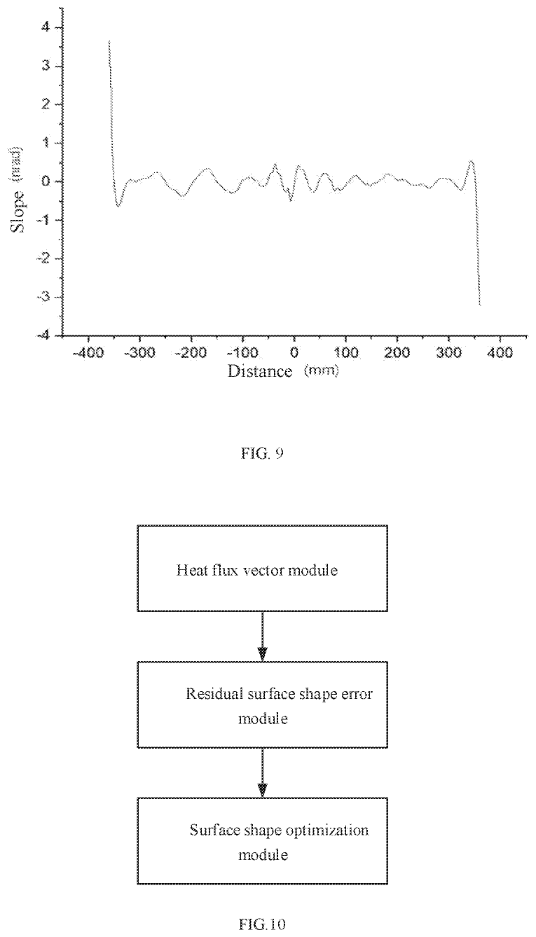

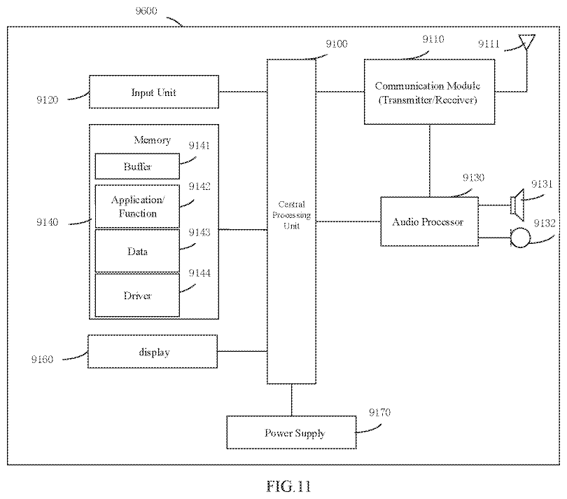

FIG. 10 is a structural block diagram of an apparatus for optimizing surface shape of a reflecting mirror according to an embodiment of the present disclosure. As shown in FIG. 10, the n apparatus for optimizing the surface shape of the reflecting mirror includes:
a heat flux vector module configured to determine each heat flux vector based on a response matrix, a thermal deformation vector and each perturbation term;
a residual surface shape error module configured to determine each residual surface shape error based on the response matrix, the thermal deformation vector and each heat flux vector satisfying constraint conditions; and
a surface shape optimization module configured to apply a heat flux vector corresponding to a minimum value of each residual surface shape error to a heating sheet of the reflecting mirror to optimize the surface shape of the reflecting mirror.

In an embodiment, the apparatus further includes:
a heat flux vector application module configured to apply heat flux vectors sequentially to each heating sheet to obtain corresponding reflecting mirror heat flux deformation data; and
a response matrix module configured to determine the response matrix from the reflecting mirror heat flux deformation data.

In an embodiment, the apparatus further includes:
a thermal power application module configured to apply light source thermal power to light spots of the reflecting mirror to obtain thermal deformation data of the reflecting mirror; and
a thermal deformation vector module configured to determine a thermal deformation vector based on the thermal deformation data of the reflecting mirror.

In an embodiment, the heat flux vector module includes:
a total deformation perturbation vector unit configured to determine each total deformation perturbation vector based on the thermal deformation vector, an initial deformation vector and each perturbation term;
a heat flux vector unit configured to determine each heat flux vector based on the response matrix and each total deformation perturbation vector.

In an embodiment, the total deformation perturbation vector unit includes:
a thermal deformation perturbation vector sub-unit configured to determine each thermal deformation perturbation vector based on a maximum value of the thermal deformation vectors, and each perturbation term;
a total deformation perturbation vector sub-unit configured to determine each total deformation perturbation vector based on the thermal deformation vector, the initial deformation vector and each thermal deformation perturbation vector.

In an embodiment, the heat flux vector unit is specifically configured to:
determine each heat flux vector based on an inverse matrix of a product of the response matrix and a transposition of the response matrix, the transposition of the response matrix and each total deformation perturbation vector.

In an embodiment, the heat flux vector module is specifically configured to:
determine each heat flux vector an equation includes the following equation:

H(M^{T}(x)M(x))⁻¹M^{T}(x)(−C(x)−K(x)+(max(K(x))+ε)I);
where, M(x) denotes the response matrix, H denotes the heat flux vector, C(x) denotes the initial deformation vector; K(x) denotes the thermal deformation vector, ε denotes the perturbation term, and −C(x)−K(x)+(max(K(x))+ε)I denotes the total deformation perturbation vector. In addition, it should be noted that the equals sign (=) in the above equation may be interpreted as roughly equal, i.e. approximately equal (≈).

In an embodiment, the residual surface shape error module includes:
a thermal deformation perturbation vector unit configured to determine each thermal deformation perturbation vector based on a maximum value of the thermal deformation vectors, and each perturbation term;
a residual surface shape error unit configured to determine each residual surface shape error based on the response matrix, the thermal deformation vector, an initial deformation vector, each thermal deformation perturbation vector and each heat flux vector satisfying constraint conditions.

In an embodiment, the residual surface shape error module is specifically configured to:
determine each residual surface shape error by an equation includes the following equation:

e=M(x)H′+C(x)+K(x)−((max(K(x))+ε)I);
where, e denotes the residual surface shape error, M(x) denotes the response matrix, H′ denotes the heat flux vector satisfying constraint conditions, C(x) denotes the initial deformation vector; K(x) denotes the thermal deformation vector, ε denotes the perturbation term, and (max(K(x))+ε)I denotes the thermal deformation perturbation vector.

In summary, the apparatus for optimizing surface shape of the reflecting mirror according to the embodiment of the present disclosure firstly determines each heat flux vector based on a response matrix, a thermal deformation vector and each perturbation term; then determines each residual surface shape error based on the response matrix, the thermal deformation vector and each heat flux vector satisfying constraint conditions; and finally applies a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

FIG. 11 is a schematic block diagram of system configuration of an electronic device 9600 according to an embodiment of the present application. As shown in FIG. 11, the electronic device 9600 may include a central processor 9100 and a memory 9140; the memory 9140 is coupled to the central processor 9100. It is worth noting that FIG. 11 is exemplary; other types of structures may also be used in addition to or instead of the structure to implement telecommunications functions or other functions.

In an embodiment, the function of the method for optimizing the surface shape of the reflecting mirror may be integrated into the central processor 9100. In this embodiment, the central processor 9100 may be configured to perform the following control of:
determining each heat flux vector based on a response matrix, a thermal deformation vector and each perturbation term;
determining each residual surface shape error based on the response matrix, the thermal deformation vector and each heat flux vector satisfying constraint conditions; and
applying a heat flux vector corresponding to a minimum value of each residual surface shape error to a heating sheet of the reflecting mirror to optimize the surface shape of the reflecting mirror.

As can be seen from the above description, the method for optimizing surface shape of the reflecting mirror provided by the present application firstly determines each heat flux vector based on a response matrix, a thermal deformation vector and each perturbation term, then determines each residual surface shape error based on the response matrix, the thermal deformation vector and each heat flux vector satisfying constraint conditions; and finally applies a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

In another embodiment, the apparatus for optimizing surface shape of the reflecting mirror may be configured separately from the central processor 9100. For example, the apparatus for optimizing the surface shape of the reflecting mirror may be configured as a chip connected to the central processor 9100, and it implements the function of the method for optimizing surface shape of the reflecting mirror by the control of the central processor 9100.

As shown in FIG. 11, the electronic device 9600 may further include a communication module 9110, an input unit 9120, an audio processor 9130, a display 9160, and a power supply 9170. It is worth noting that the electronic device 9600 is not necessarily required to include all of the components shown in FIG. 11; in addition, the electronic device 9600 may further include components not shown in FIG. 11, with reference to the prior art.

As shown in FIG. 11, the central processor 9100, sometimes referred to as a controller or an operational control, may include a microprocessor or other processor apparatuses and/or logic apparatuses, the central processor 9100 receives inputs and controls operation of the components of the electronic device 9600.

In this embodiment, the memory 9140 may be, for example, one or more of a buffer, a flash memory, a hard drive, a removable medium, a volatile memory, a non-volatile memory, or other suitable apparatuses. The above-described failure-related information may be stored, and in addition, a program for executing the relevant information may be stored. And the central processor 9100 may execute the program stored in the memory 9140 to implement information storage or processing and the like.

The input unit 9120 provides an input to the central processor 9100. The input unit 9120 is, for example, a key or a touch input apparatus. The power supply 9170 is used to provide electric power to the electronic device 9600. The display 9160 is used for displaying objects to be displayed, such as images and text, and the like. The display may be, for example, an LCD display, but is not limited thereto.

The memory 9140 may be a solid state memory such as read only memory (ROM), random access memory (RAM), SIM card, or the like. The memory may also be such a memory that it saves information even when power is off, on which data can be selectively erased and more data is set, and an example of which is sometimes referred to as an EPROM (Easerable Programmable ROM) or the like. The memory 9140 may also be some other types of devices. The memory 9140 includes a buffer memory 9141 (sometimes referred to as a buffer). The memory 9140 may include an application/function storage unit 9142 for storing application programs and function programs or a flow for performing operation of an electronic device 9600 by the central processor 9100.

The memory 9140 may also include a data storage unit 9143 for storing data, such as contacts, digital data, pictures, sounds, and/or any other data used by the electronic device. A drive program storage unit 9144 of the memory 9140 may include various drive programs of the electronic device for communication functions and/or for executing other functions of the electronic device, such as a messaging application, an address book application, and the like.

The communication module 9110 is a transmitter/receiver 9110 that transmits and receives signals via an antenna 9111. The communication module (transmitter/receiver) 9110 is coupled to the central processor 9100 to provide input signals and to receive output signals, which may be the same as in the case of conventional mobile communication terminals.

Based on different communication technologies, a plurality of communication modules 9110, such as a cellular network module, a Bluetooth module, and/or a wireless local area network module and the like may be provided in the same electronic device. The communication module (transmitter/receiver) 9110 is also coupled to a speaker 9131 and a microphone 9132 via an audio processor 9130 to provide an audio output via the speaker 9131, and to receive an audio input from the microphone 9132, thereby implementing the usual telecommunications functions. The audio processor 9130 may include any suitable buffer, decoder, amplifier, or the like. In addition, the audio processor 9130 is also coupled to the central processor 9100 so that sound can be recorded on the local machine by the microphone 9132, and the sound stored on the local machine can be played through the speaker 9131.

The embodiment of the present disclosure also provides a computer-readable storage medium capable of implementing all steps of the method for optimizing surface shape of the reflecting mirror in which the execution body is either a server or a client in the above embodiment, the computer-readable storage medium stores a computer program, and when executed by a processor, the computer program implements all of the steps of the method for optimizing surface shape of the reflecting mirror in the embodiment described above. For example, the processor, when executing the computer program, implements the steps of:
determining each heat flux vector based on a response matrix, a thermal deformation vector and each perturbation term;
determining each residual surface shape error based on the response matrix, the thermal deformation vector and each heat flux vector satisfying constraint conditions; and
applying a heat flux vector corresponding to a minimum value of each residual surface shape error to a heating sheet of the reflecting mirror to optimize the surface shape of the reflecting mirror.

In summary, the computer-readable storage medium according to the embodiment of the present disclosure firstly determines each heat flux vector based on a response matrix, a thermal deformation vector and each perturbation term; then determines each residual surface shape error based on the response matrix, the thermal deformation vector and each heat flux vector satisfying constraint conditions; and finally applies a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

The embodiment of the present disclosure also provides a computer program product capable of implementing all steps of the method for optimizing surface shape of the reflecting mirror in which the execution body is either a server or a client in the above embodiment, the computer program product includes a computer program/instruction, when executed by a processor, the computer program/instruction implements all of the steps of the method for optimizing surface shape of the reflecting mirror in the embodiment described above. For example, the processor, when executing the computer program, implements the steps of:
determining each heat flux vector based on a response matrix, a thermal deformation vector and each perturbation term;
determining each residual surface shape error based on the response matrix, the thermal deformation vector and each heat flux vector satisfying constraint conditions; and
applying a heat flux vector corresponding to a minimum value of each residual surface shape error to a heating sheet of the reflecting mirror to optimize the surface shape of the reflecting mirror.

In summary, the computer program product according to the embodiment of the present disclosure firstly determines each heat flux vector based on a response matrix, a thermal deformation vector and each perturbation term; then determines each residual surface shape error based on the response matrix, the thermal deformation vector and each heat flux vector satisfying constraint conditions; and finally applies a heat flux vector corresponding to a minimum value of each residual surface shape error to a heating sheet of the reflecting mirror to optimize the surface shape of the reflecting mirror, so as to be able to quickly determine an effective surface shape optimization scheme and meet the requirement of high-precision surface shape.

The purpose, technical solution and beneficial effect of the disclosure have been further described in detail in the above specific embodiments, it should be understood that the above contents are merely specific embodiments of the disclosure and are not for limiting protection scope of the disclosure, and any modifications, equivalent replacements, improvements and the like within the spirit and principle of the present disclosure shall be included within the protection scope of the present disclosure.

The various embodiments in the specification are described in a progressive manner, and the same or similar parts between the various embodiments may be referred to each other, and each embodiment focuses on the differences from the other embodiments. In particular, the hardware plus program type embodiment is described simply since it is substantially similar to the method embodiment; please refer to the description of the method embodiment for the relevant content.

Specific embodiments of the present specification have been described in the above. Other embodiments fall within the scope of the appended claims. In some cases, the actions or steps recited in the claims may be performed in a different order from that in the embodiments and still achieve the desired results. In addition, the processes depicted in the drawings do not necessarily require a particular order or a sequential order shown in order to achieve the desired results. In some embodiments, multi-tasking and parallel processing may also be possible or may be advantageous.

Although the embodiments of the specification provide the method operation steps as described in the embodiment or the flowcharts, more or less operation steps may be included based on the conventional or non-creative means. The order of the steps listed in the embodiments is merely one of various execution orders of the steps, rather than a unique execution order. When an actual apparatus or a terminal product is executed in practice, it may be executed sequentially or in parallel according to the methods illustrated in the embodiments or drawings (e.g., by a parallel processor or a multi-threaded processing environment and even a distributed data processing environment). The term “comprise”, “include” or any other variant intends to cover the non-exclusive inclusions, so that a process, a method, a product or an apparatus comprising a series of elements include not only those elements, but also other elements not explicitly listed, or further include inherent elements of such process, method, product or apparatus. In a case where there is no further limitation, it does not exclude other identical elements existing in the process, method, product or apparatus comprising the elements.

Those skilled in the art will also appreciate that the various illustrative logical blocks, units, and steps set forth in the embodiments of the present disclosure may be implemented by electronic hardware, computer software, or a combination of both. In order to clearly show the interchangeability of hardware and software, the functions of the various illustrative components, units, and steps described above have been generally described. Whether such functions are implemented by hardware or software depends on the design requirements of the overall system and the particular application. Those skilled in the art may implement the described functions using various methods for each particular application, but such implementation should not be construed as going beyond the scope of protection of the embodiments of the present disclosure.

The various illustrative logical blocks, or units, or apparatus described in embodiments of the present disclosure may be implemented or operated to achieve the described functions by the design of a general purpose processor, a digital signal processor, an application specific integrated circuit (ASIC), a field programmable gate array or other programmable logic devices, a discrete gate or transistor logic, a discrete hardware component, or any combination thereof. The general purpose processor may be a microprocessor, or alternatively, the general purpose processor may be any conventional processor, controller, microcontroller, or state machine. The processor may also be implemented by a combination of computing devices, such as a digital signal processor and a microprocessor, a plurality of microprocessors, one or more microprocessors in conjunction with a digital signal processor core, or any other similar configuration.

The steps of the method or algorithm described in embodiments of the present disclosure may be embedded directly in hardware, a software module executed by a processor, or a combination of both. The software module may be stored in an RAM memory, a flash memory, an ROM memory, an EPROM memory, an EEPROM (Electrically Erasable Programmable ROM) memory, a register, a hard disk, a removable disk, CD-ROM, or any other form of storage medium known in the art. Illustratively, the storage medium can be connected to the processor so that the processor can read information from the storage medium and can store and write information to the storage medium. Alternatively, the storage medium may also be integrated into the processor. The processor and the storage medium may be provided in the ASIC (Application Specific Integrated Circuit) which may be provided in a user terminal. Alternatively, the processor and the storage medium may be provided in different components in the user terminal.

In one or more exemplary designs, the above functions described in embodiments of the present disclosure may be implemented in hardware, software, firmware, or any combination of the three. If implemented in software, these functions may be stored on a computer-readable medium or transmitted as one or more instructions or codes to a computer-readable medium. The computer-readable medium includes a computer storage medium and a communication medium facilitating the transportation of the computer program from one location to another. The storage medium can be any available medium that can be accessed by a general purpose or special purpose computer. For example, such computer-readable medium may include, but is not limited to RAM, ROM, EEPROM, CD-ROM or other optical disk storage, magnetic disk storage or other magnetic storage devices, or any other medium that may be used to carry or store program code in the form of instructions or data structures and other program code readable by a general purpose or special purpose computer, or a general purpose or special purpose processor. In addition, any connection may be suitably defined as a computer-readable medium. If the software is transmitted from a web site, a server or other remote sources over a coaxial cable, an optical fiber cable, twisted-pair cabling, a digital subscriber line (DSL) or in a wireless manner such as infrared, wireless and microwave, it is also included in the defined computer-readable medium. The disk and the disc include compressed magnetic disks, laser disks, optical disks, DVDs, floppy disks, and Blu-ray disks. The disc typically reproduces data magnetically, while the disk typically optically reproduces data with a laser. Combination of the above may also be included in a computer-readable medium.

Persons skilled in the art shall understand that, the embodiments of the present disclosure can be provided as a method, a system or a computer program product. Therefore, the present disclosure can adopt the forms of a full hardware example, a full software example, or combination of a software example and a hardware example. Moreover, the present disclosure can adopt the form of a computer program product that is implemented on one or more computer-usable storage medium (including but not limited to a disk memory, a CD-ROM, an optical memory, and etc.) including computer-usable program codes.

The disclosure is described with reference to flow diagrams and/or block diagrams of the method, the apparatus (system) and the computer program product according to the embodiment of the disclosure. It should be understood that each flow and/or block in the flow diagrams and/or block diagrams, and the combination of the flows and/or blocks in the flow diagrams and/or block diagrams can be achieved by computer program instructions. These computer program instructions can be provided to a CPU of a general-purpose computer, a special-purpose computer, an embedded processor or other programmable data processing device to produce a machine, so that a device for achieving functions designated in one or more flows in the flow diagrams and/or one or more blocks in the block diagrams can be generated by the instructions executed by the CPU of the computer or other programmable data processing device.

These computer program instructions can also be stored in a computer-readable memory that can guide a computer or other programmable data processing device to operate in a special way, so that the instruction stored in the computer-readable memory generates a manufactured product including an instruction device which achieves functions designated in one or more flows in the flow diagrams and/or one or more blocks in the block diagrams.

These computer program instructions may also be loaded onto the computer or other programmable data processing devices, so that a series of operation steps are performed on the computer or other programmable data processing devices to produce a processing realized by the computer, thus the instructions executed on the computer or other programmable devices provide step(s) for realizing function(s) specified in one or more flows in the flowchart and/or one or more blocks in the block diagram.

The disclosure adopts specific embodiments to explain the principle and implementation way of the disclosure. The above embodiments are described merely for helping to understand the method and core concept of the disclosure; in addition, a person skilled in the art can, on the basis of the concept of the disclosure, make modifications to both of the specific embodiments and application scope. In conclusion, contents disclosed herein should not be understood as limitation to the disclosure.

What is claimed is:

1. A method for optimizing surface shape of a reflecting mirror, comprising:
determining each heat flux vector based on a response matrix, a thermal deformation vector and each perturbation term;
determining each residual surface shape error based on the response matrix, the thermal deformation vector and each heat flux vector satisfying constraint conditions; and
applying a heat flux vector corresponding to a minimum value of each residual surface shape error to a heating sheet of the reflecting mirror to optimize the surface shape of the reflecting mirror.

2. The method for optimizing surface shape of a reflecting mirror according to claim 1, wherein the method further comprises:
applying heat flux vectors sequentially to each heating sheet to obtain corresponding reflecting mirror heat flux deformation data; and
determining the response matrix from the reflecting mirror heat flux deformation data.

3. The method for optimizing surface shape of a reflecting mirror according to claim 1, wherein the method further comprises:
applying light source thermal power to light spots of the reflecting mirror to obtain thermal deformation data of the reflecting mirror; and
determining the thermal deformation vector based on the thermal deformation data of the reflecting mirror.

4. The method for optimizing surface shape of a reflecting mirror according to claim 1, wherein the determining each heat flux vector based on the response matrix, the thermal deformation vector and each perturbation term comprises:
determining each total deformation perturbation vector based on the thermal deformation vector, an initial deformation vector and each perturbation term; and
determining each heat flux vector based on the response matrix and each total deformation perturbation vector.

5. The method for optimizing surface shape of a reflecting mirror according to claim 4, wherein the determining each total deformation perturbation vector based on the thermal deformation vector, the initial deformation vector and each perturbation term comprises:
determining each thermal deformation perturbation vector based on a maximum value of the thermal deformation vectors, and each perturbation term; and
determining each total deformation perturbation vector based on the thermal deformation vector, the initial deformation vector and each thermal deformation perturbation vector.

6. The method for optimizing surface shape of a reflecting mirror according to claim 4, wherein the determining each heat flux vector based on the response matrix and each total deformation perturbation vector comprises:
determining each heat flux vector based on an inverse matrix of a product of the response matrix and a transposition of the response matrix, the transposition of the response matrix and each total deformation perturbation vector.

7. The method for optimizing surface shape of a reflecting mirror according to claim 4, wherein determining each heat flux vector by an equation comprises the following equation:
H=(M^{T}(x)M(x))⁻¹M^{T}(x)(−C(x)−K(x)+(max(K(x))+ε)I);
where, M(x) denotes the response matrix, H denotes the heat flux vector, C(x) denotes the initial deformation vector; K(x) denotes the thermal deformation vector, ε denotes the perturbation term, and −C(x)−K(x)+(max(K(x))+ε)I denotes the total deformation perturbation vector.

8. The method for optimizing surface shape of a reflecting mirror according to claim 1, wherein determining each residual surface shape error based on the response matrix, the thermal deformation vector and each heat flux vector satisfying constraint conditions comprises:
determining each thermal deformation perturbation vector based on a maximum value of the thermal deformation vectors, and each perturbation term; and
determining each residual surface shape error based on the response matrix, the thermal deformation vector, an initial deformation vector, each thermal deformation perturbation vector and each heat flux vector satisfying constraint conditions.

9. The method for optimizing surface shape of a reflecting mirror according to claim 8, wherein determining each residual surface shape error by an equation comprises the following equation:
e=M(x)H′+C(x)+K(x)−((max(K(x))+ε)I);
where, e denotes the residual surface shape error, M(x) denotes the response matrix, H′ denotes the heat flux vector satisfying constraint conditions, C(x) denotes the initial deformation vector; K(x) denotes the thermal deformation vector, and (max(K(x))+ε)I denotes the thermal deformation perturbation vector.

10. An apparatus for optimizing surface shape of a reflecting mirror, comprising:
a heat flux vector module configured to determine each heat flux vector based on a response matrix, a thermal deformation vector and each perturbation term;
a residual surface shape error module configured to determine each residual surface shape error based on the response matrix, the thermal deformation vector and each heat flux vector satisfying constraint conditions; and
a surface shape optimization module configured to apply a heat flux vector corresponding to a minimum value of each residual surface shape error to a heating sheet of the reflecting mirror to optimize the surface shape of the reflecting mirror.

11. The apparatus for optimizing surface shape of a reflecting mirror according to claim 10, wherein the apparatus further comprises:
a heat flux vector application module configured to apply heat flux vectors sequentially to each heating sheet to obtain corresponding reflecting mirror heat flux deformation data; and
a response matrix module configured to determine the response matrix from the reflecting mirror heat flux deformation data.

12. The apparatus for optimizing surface shape of a reflecting mirror according to claim 10, wherein the apparatus further comprises:
a thermal power application module configured to apply light source thermal power to light spots of the reflecting mirror to obtain thermal deformation data of the reflecting mirror; and
a thermal deformation vector module configured to determine the thermal deformation vector based on the thermal deformation data of the reflecting mirror.

13. The apparatus for optimizing surface shape of a reflecting mirror according to claim 10, wherein the heat flux vector module comprises:
a total deformation perturbation vector unit configured to determine each total deformation perturbation vector based on the thermal deformation vector, an initial deformation vector and each perturbation term; and
a heat flux vector unit configured to determine each heat flux vector based on the response matrix and each total deformation perturbation vector.

14. The apparatus for optimizing surface shape of a reflecting mirror according to claim 13, wherein the total deformation perturbation vector unit comprises:
a thermal deformation perturbation vector sub-unit configured to determine each thermal deformation perturbation vector based on a maximum value of the thermal deformation vectors, and each perturbation term; and
a total deformation perturbation vector sub-unit configured to determine each total deformation perturbation vector based on the thermal deformation vector, the initial deformation vector and each thermal deformation perturbation vector.

15. The apparatus for optimizing surface shape of a reflecting mirror according to claim 13, wherein the heat flux vector unit is specifically configured to:
determine each heat flux vector based on an inverse matrix of a product of the response matrix and a transposition of the response matrix, the transposition of the response matrix and each total deformation perturbation vector.

16. The apparatus for optimizing surface shape of a reflecting mirror according to claim 13, wherein the heat flux vector module is specifically configured to:
determine each heat flux vector an equation comprises the following equation:
H=(M^{T}(x)M(x))⁻¹M^{T}(x)(−C(x)−K(x)+(max(K(x))+ε)I);
where, M(x) denotes the response matrix, H denotes the heat flux vector, C(x) denotes the initial deformation vector; K(x) denotes the thermal deformation vector, ε denotes the perturbation term, and −C(x)−K(x)+(max(K(x))+ε)I denotes the total deformation perturbation vector.

17. The apparatus for optimizing surface shape of a reflecting mirror according to claim 10, wherein the residual surface shape error module comprises:
a thermal deformation perturbation vector unit configured to determine each thermal deformation perturbation vector based on a maximum value of the thermal deformation vectors, and each perturbation term; and
a residual surface shape error unit configured to determine each residual surface shape error based on the response matrix, the thermal deformation vector, an initial deformation vector, each thermal deformation perturbation vector and each heat flux vector satisfying constraint conditions.

18. The apparatus for optimizing surface shape of a reflecting mirror according to claim 17, wherein the residual surface shape error module is specifically configured to:
determine each residual surface shape error by an equation comprises the following equation:
e=M(x)H′+C(x)+K(x)−((max(K(x))+ε)I);
where, e denotes the residual surface shape error, M(x) denotes the response matrix, H′ denotes the heat flux vector satisfying constraint conditions, C(x) denotes the initial deformation vector; K(x) denotes the thermal deformation vector, ε denotes the perturbation term, and (max(K(x))+ε)I denotes the thermal deformation perturbation vector.

19. An electronic device, comprising a memory, a processor, and a computer program stored in the memory and runnable on the processor, wherein when executing the computer program, the processor implements steps of the method for optimizing surface shape of a reflecting mirror according to claim 1.
